(19) United States
(12) Patent Application Publication
(10) Pub. No.: US 2009/0278807 A1
(43) Pub. Date: Nov. 12, 2009

(54) PASSWORD INPUT USING TOUCH DURATION CODE

(75) Inventor: LEHONG HU, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/119,303

(22) Filed: May 12, 2008

(51) Int. Cl. G06F 3/041

(52) U.S. Cl. 345/173

(57) ABSTRACT

On a device such as a music player that has no keypad with which to enter a password, the duration of each user touch on a touchscreen is noted, with different touch durations being correlated to respective code elements. A sequence of code elements may be correlated to a predetermined code word, and in turn a sequence of code words can establish a password to permit access to the content on the device.

### I. FIELD OF THE INVENTION

This application relates to establishing codes based on the sequential set of the durations a user touches a touch-sensitive surface for, e.g., permitting the inputting of a password without use of a keypad or keyboard.

### II. BACKGROUND OF THE INVENTION

Some device such as music players for playing, e.g., MP3 digital music do not have alpha-numeric keypads or keyboards with which to enter data. Instead, the devices may simply present, on a touch screen, user interfaces with predetermined commands or selections to enable a user to easily and intuitively select a title for play. As understood herein, however, it might be desirable to limit access to content to users possessing a predetermined password.

As also understood herein, it may be possible to configure other devices, such as a power tool or a car key, to have a single pressable button or small touch interface to gain the capability of access control.

### SUMMARY OF THE INVENTION

A device that has no keypad with which to enter a password includes a touch member generating a signal when touched by a person. A processor communicates with the touch member and is configured to receive touch signals from the touch member. The processor determines respective touch durations of uninterrupted touches on the touch member, with a first touch duration representing a first code element and a second touch duration representing a second code element. A sequence of code elements represents a predetermined code word.

In some embodiments the touch member can be a touch screen and the device can be a music player. Other devices that may incorporate a touch pad to use present principles may include, e.g., a door access remote control (to ensure only authorized personnel can enter), a digital voice recorder (to ensure only authorized personnel can record/play back sound), a firearm, or a power tool (to ensure only authorized personnel may use the device).

A sequence of code words may establish a password. The device may permit a user to play content stored on the device only upon receipt of a predetermined sequence of code elements. A code element need not depend on a pressure with which a user touches the touch member, but only the duration a user's finger is sensed against the touch member.

In another aspect a method includes establishing a correlation between first and second durations and respective first and second code elements. The correlation is provided to a device, which subsequently receives tactile signals on the device. It may then be determined whether the tactile signals establish a predetermined pass code by using the correlation.

In another aspect, an apparatus has a housing, processor means in the housing, and tactile signal means in the housing and communicating signals representing tactile user input to the processor means. Tangible information storage means are accessible to the processor means and include instructions to cause the processor means to, based on the signals, determine a duration of each uninterrupted touch by a user. The processor also correlates each duration to a respective code element and then determines whether a sequence of code elements matches a predetermined sequence.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example device;

FIG. 2 is a flow chart of the logic used for establishing the touch duration code; and

FIG. 3 is a flow chart of example logic that can be implemented by the device of FIG. 1.

### DETAILED DESCRIPTION OF THE PREFERRED EMBODIMENT

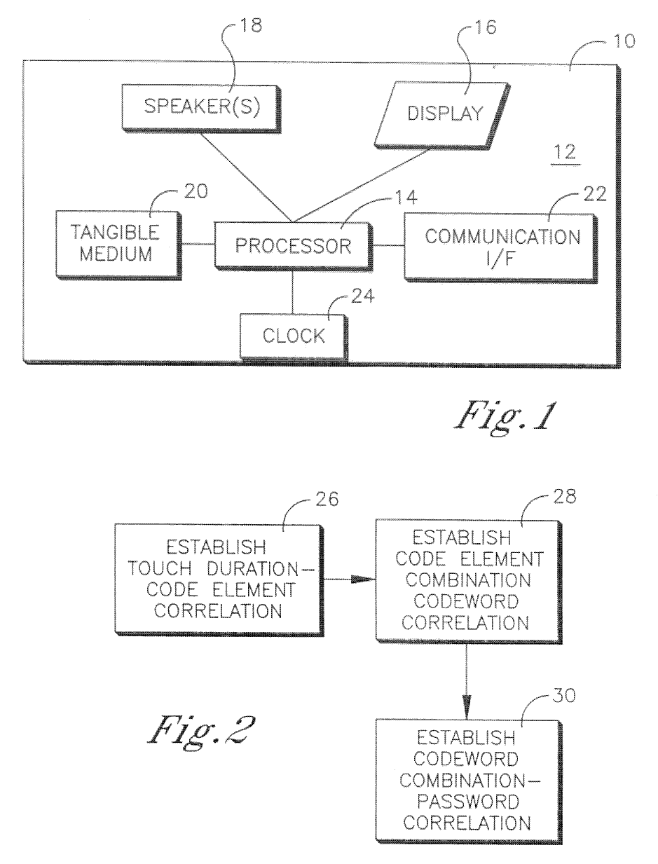

Referring initially to FIG. 1, a device 10 may have a lightweight portable housing 12 containing a processor 14 that can be implemented by, e.g., a suitable computer processor or computing circuit. The processor 14 can output visual data on a display 16 which may be a touchscreen display. The visual data may be, e.g., song titles, and thus in one example the device 10 is a music player that plays audio data on speakers 18. The data may be stored in a tangible computer readable storage medium 20, which may also store computer instructions executable by the processor 14 to undertake logic herein. The medium 20 may represent, without limitation, any one or a combination of solid state storage, disk storage, removable and non-removable storage, etc. In other embodiments, a touch pad separate from the display 16 can be provided, but in any case the example device 10 shown in FIG. 1 does not have an alphanumeric keyboard or keypad.

Other devices that may incorporate a touch member input device to use present principles may include, e.g., a door access remote control (to ensure only authorized personnel can enter), a digital voice recorder (to ensure only authorized personnel can record/play back sound), a firearm, or a power tool (to ensure only authorized personnel may use the device). For simpler devices, a touch pad may be used or a pressable button or key that may be held down for desired durations to generate the code elements discussed herein. Also, the processor in such devices may not be a computer microprocessor but may be implemented more simply by an analog or digital logic circuit accessing a non-volatile memory such as EPROM or flash storage. Such devices need not incorporate a display at all.

One or more communication interfaces 22 may be used by the processor 14 to acquire data including songs for storage on the medium 20. The interface(s) 22 may include a universal serial bus (USB) interface, a network interface such as a modem, a Bluetooth interface, etc. The device 10 may also be a video player, in which case video may be stored on the medium 20 and output by the processor 14 on the display 16. Also, a clock 24 may provide time input to the processor 14 as shown.

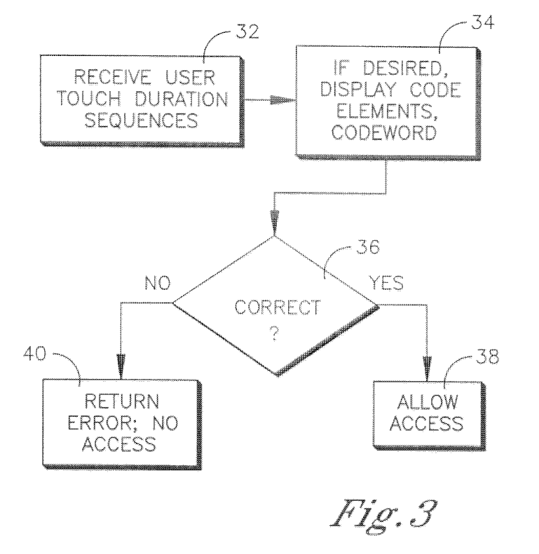

Now referring to FIG. 2, at block 26 a correlation is established between uninterrupted touch durations and code elements. As but one non-limiting example, a touch duration of one-half of a second might be correlated to the code element “1”, a touch duration of a full (1.0) second to the code element “2”, and a touch duration of a second and a half to the code element “3”. The pressure with which a user might subsequently touch the display 16 to input a tactile signal is not implicated in the subsequent determination of what code element has been received; only the duration of the user's uninterrupted touch on the display 16 is used to determine the code element.

In establishing the correlation at block 26, either a range of touch duration might be correlated to a code element (e.g., any touch less than 0.75 seconds might be correlated to a code element “1”, and a touch duration greater than 0.75 seconds but less than 1.25 seconds might be correlated to a code element “2”, and so on) or a single unique duration might be correlated to each code element. In the latter case, during operation described below the processor 14 can round actual touch durations to, e.g., the nearest single unique duration representing a code element.

Once touch durations have been correlated to code elements, the logic moves to block 28 to correlate one or more sequences of code elements to a respective code word. For example, the code element sequence 1-3-2 might be correlated to a code word “A”, whereas the code element sequence 1-2-3 might be correlated to a code word “B”. Then, if desired at block 30 a sequence of code words can be correlated to a respective password. This latter step may be executed by a user of the device at an in initial power-on set-up screen display, wherein the user is prompted to input a sequence of touches to establish a user-desired sequence of code elements, code words, and thus a password. Of course, a password can be established directly from a sequence of code elements if desired.

Once the code correlations have been established as described, they are stored in the medium 20 in, e.g., table format or other correlation data structure. Subsequently, the user may cause the processor to display a login presentation or similar on the display 16, prompting the user to enter a password. In response, the user touches the display 16 plural times, with each uninterrupted touch period separated from the next period when the user lifts his finger off the display. These touch durations are received at block 32, it being understood that the processor 14 may use clock 24 signals to determine the duration during which it receives indication from the display 16 that a user is touching the display. In any case, the processor 14 accesses the correlation data structure using each calculated duration as entering argument to determine the corresponding code element associated with the tactile signal input by the user.

Block 34 indicates that if desired, code elements and/or code words may be presented on the display 16 to the user as visual feedback as the user enters tactile signals. In any case, at decision diamond 36 the processor 14 determines whether a sequence of code elements input by the user (or a sequence of code words derived from respective sequences of code elements) matches an approved password, and if so, the user is granted access at block 38 to, e.g., music or video content on the medium 20. Otherwise, access is denied at block 40 and “error” may be returned if desired.

While the particular PASSWORD INPUT USING TOUCH DURATION CODE is herein shown and described in detail, it is to be understood that the subject matter which is encompassed by the present invention is limited only by the claims.

What is claimed is:

1. A device that has no keypad with which to enter a password, comprising:
a touch member generating a signal when touched by a person; and
a processor communicating with the touch member and configured to receive touch signals therefrom, the processor determining a respective touch duration of at least some uninterrupted touches on the touch member, a first touch duration representing a first code element and a second touch duration representing a second code element, a sequence of code elements representing a predetermined code word.

2. The device of claim 1, wherein the touch member is a touch screen.

3. The device of claim 1, wherein the device is a music player.

4. The device of claim 1, wherein a sequence of code words establishes a password.

5. The device of claim 1, wherein the device permits a user to play content stored on the device only upon receipt of a predetermined sequence of code elements.

6. The device of claim 1, wherein a code element does not depend on a pressure with which a user touches the touch member.

7. A method, comprising:
establishing a correlation between at least first and second durations and respective first and second code elements;
providing the correlation to a device;
receiving tactile signals on the device; and
determining whether the tactile signals establish a predetermined pass code at least in part by using the correlation.

8. The method of claim 7, wherein the tactile signals are received from a touch screen.

9. The method of claim 7, wherein the device is a music player.

10. The method of claim 7, wherein the device permits a user to play content stored on the device only upon receipt of a predetermined sequence of tactile signals.

11. The method of claim 7, wherein a touch signal does not depend on a pressure with which a user touches the touch member.

12. The method of claim 7, wherein the device does not have an alphanumeric keypad.

13. Apparatus, comprising:
a housing;
processor means in the housing;
tactile signal means in the housing and communicating signals representing tactile user input to the processor means;
tangible computer storage means accessible to the processor means and including instructions to cause the processor means to:
based at least in part on the signals, determine a duration of each uninterrupted touch by a user;
correlate each duration to a respective code element; and
determine whether a sequence of code elements matches a predetermined sequence.

14. The apparatus of claim 13, wherein if the sequence of code elements matches a predetermined sequence, the processor means grants access to content and otherwise prohibits access to the content.

15. The apparatus of claim 14, wherein the content is music.

16. The apparatus of claim 13, wherein the tactile signal means is a touch screen.

17. The apparatus of claim 13, wherein a sequence of code elements establishes a code word and a sequence of code words establishes a password.

18. The apparatus of claim 13, wherein a code element does not depend on a pressure with which a user touches the tactile signal means, but only on the duration of touch.
